(19) United States
(12) Patent Application Publication
(10) Pub. No.: US 2026/0274161 A1
(43) Pub. Date: Sep. 17, 2026

(54) WARNING SYSTEM FOR WORK MACHINE

(71) Applicant: Caterpillar Paving Products Inc., Brooklyn Park, MN (US)

(72) Inventor: Brian Schlenker, Shoreview, MN (US)

(73) Assignee: Caterpillar Paving Products Inc., Brooklyn Park, MN (US)

(21) Appl. No.: 19/077,475

(22) Filed: Mar. 12, 2025

(51) Int. Cl. B60Q 9/00; B60Q 5/00; E01C 23/06

(52) U.S. Cl. CPC B60Q 9/00; B60Q 5/005; E01C 23/065; E01C 2301/00

(57) ABSTRACT

A warning system for a work machine includes a rotor adapted to engage with a main clutch of the work machine. The warning system includes a first sensor configured to generate a first signal indicative of a speed of the rotor. The warning system includes a controller communicably coupled with the first sensor. The controller is configured to receive the first signal indicative of the speed of the rotor from the first sensor, determine that the rotor is in an operational mode based on a receipt of the first signal from the first sensor, and determine an engagement between the rotor and the main clutch. The controller is configured to generate a first output signal if the rotor is in the operational mode or the rotor is in engagement with the main clutch to indicate that the rotor is in the operational mode to a user of the work machine.

### TECHNICAL FIELD

The present disclosure relates to work machines, and more particularly, to a warning system and a method of generating a warning for a work machine.

### BACKGROUND

Work machines, such as rotary mixers and cold planers, are often used for repairing or stabilization of various surfaces. Such work machines typically includes a rotor. A gearbox is coupled to the rotor to transfer power from a power source of the work machine to the rotor through a main clutch. The gearbox may allow rotation of the rotor at various speeds. The rotor includes cutting tools that engage with the surface being worked upon.

For successful and continuous operation of the work machine, the rotor needs to be checked for repair and/or maintenance multiple times a day. As such, it is desirable that the rotor is in a non-operational state when an operator interacts with or approaches the rotor.

U.S. Application Number 2024/0125091 describes a machine controller that controls an action of the construction machine; an external operation controller that controls unmanned operation that does not require operation by an operator riding in an operation room, by generating a control signal according to an operation signal received from an outside via a communication terminal, and sending the control signal to the machine controller; an approach permission signaling light that signals permission for a worker to approach the construction machine; and an action request signaling light that signals a request for riding in the operation room and performing a particular action to a nearby worker are provided, and the external operation controller is configured to control the approach permission signaling light to be turned on when it is decided that approach of the worker to the construction machine can be tolerated according to information collected by the machine controller, and also control the action request signaling light to be turned on when it is decided that it is necessary to request a nearby worker to take a particular action. Thereby, it is possible to succinctly notify nearby workers and a manager of a machine-body action state, and to realize both the safety and work efficiency of the workers near the machine body and the manager.

### SUMMARY OF THE DISCLOSURE

In an aspect of the present disclosure, a warning system for a work machine is provided. The work machine includes a rotor adapted to engage with a main clutch of the work machine. The warning system includes a first sensor configured to generate a first signal indicative of a speed of the rotor. The warning system also includes a controller communicably coupled with the first sensor. The controller is configured to receive the first signal indicative of the speed of the rotor from the first sensor. The controller is also configured to determine that the rotor is in an operational mode based on a receipt of the first signal from the first sensor. The controller is further configured to determine an engagement between the rotor and the main clutch. The controller is configured to generate a first output signal if the rotor is in the operational mode or the rotor is in engagement with the main clutch. The first output signal indicates that the rotor is in the operational mode to a user of the work machine.

In another aspect of the present disclosure, a work machine is provided. The work machine includes a frame. The work machine also includes a main clutch supported on the frame. The work machine further includes a gearbox supported on the frame. The work machine includes a rotor adapted to engage with the main clutch via the gearbox. The work machine also includes a warning system. The warning system includes a first sensor configured to generate a first signal indicative of a speed of the rotor. The warning system also includes a controller communicably coupled with the first sensor. The controller is configured to receive the first signal indicative of the speed of the rotor from the first sensor. The controller is also configured to determine that the rotor is in an operational mode based on a receipt of the first signal from the first sensor. The controller is further configured to determine an engagement between the rotor and the main clutch. The controller is configured to generate a first output signal if the rotor is in the operational mode or the rotor is in engagement with the main clutch. The first output signal indicates that the rotor is in the operational mode to a user of the work machine.

In yet another aspect of the present disclosure, a method of generating a warning for a work machine is provided. The method includes generating, by at least one first sensor, a first signal indicative of a speed of a rotor of the work machine. The method also includes receiving, by a controller of the work machine, the first signal indicative of the speed of the rotor from the first sensor. The controller is communicably coupled with the first sensor. The method further includes determining, by the controller, that the rotor is in an operational mode based on a receipt of the first signal from the first sensor. The method includes determining, by the controller, an engagement between the rotor and a main clutch of the work machine. The method also includes generating, by the controller, a first output signal if the rotor is in the operational mode or the rotor is in engagement with the main clutch. The method further includes indicating, to a user of the work machine, that the rotor is in the operational mode based on the generation of the first output signal.

Other features and aspects of this disclosure will be apparent from the following description and the accompanying drawings.

### BRIEF DESCRIPTION OF THE DRAWINGS

FIG. 1 is a schematic side view of an exemplary work machine;

FIG. 2 is a perspective view of a portion of the work machine of FIG. 1;

FIG. 3 is a block diagram of a warning system for the work machine of FIG. 1, according to an example of the present disclosure; and

FIG. 4 is a flowchart of a method of generating a warning for the work machine of FIG. 1, according to an example of the present disclosure.

### DETAILED DESCRIPTION

Wherever possible, the same reference numbers will be used throughout the drawings to refer to the same or like parts.

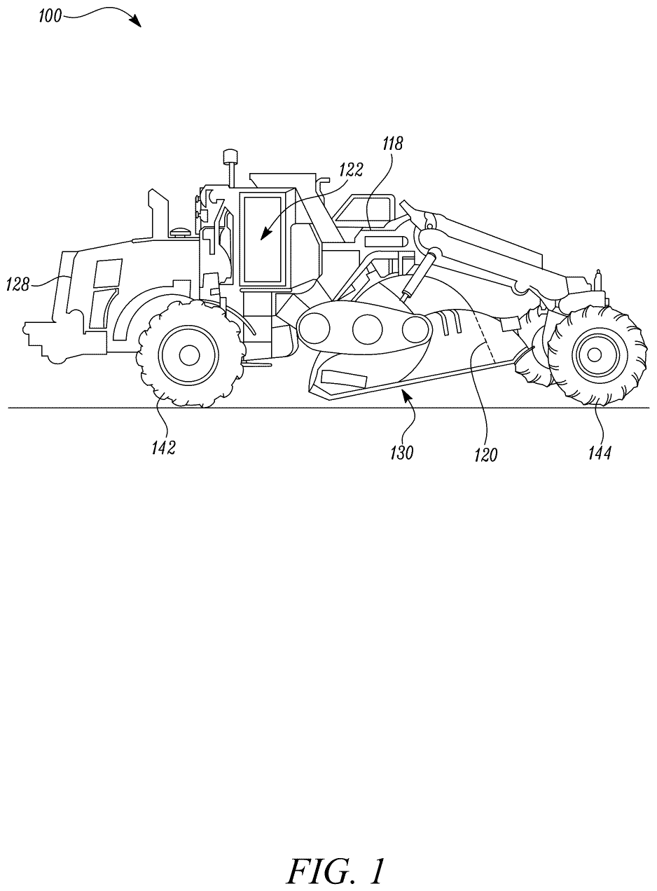

FIG. 1 is a schematic side view of an exemplary work machine 100. In the illustrated example of FIG. 1, the work machine 100 is a rotary mixer. Alternatively, the work machine 100 may include a cold planer, a stabilizer, or any other work machine that includes a rotor. In an example, the cold planers grind off or otherwise mill a portion of a work surface, such as, roads, pavements, or other surfaces. As another example, the rotary mixer mixes and stabilizes paving materials.

The work machine 100 includes a frame 118. The frame 118 supports various components of the work machine 100. An enclosure 128 defined on the frame 118 holds a power source (not shown) therein. The power source may be an engine, such as an internal combustion engine, a battery system, a fuel cell, and so on. The power source generates power that is provided to various components of the work machine 100 for operational and mobility requirements.

The work machine 100 also includes an operator cabin 122. An operator may be seated within the operator cabin 122 to perform, control, and/or observe work operations. The operator cabin 122 may include various Input/Output devices that may be used to control one or more functions or operations related to the work machine 100.

The work machine 100 also includes a set of ground engaging members 142, 144. The ground engaging members 142, 144 are operably coupled to the power source and supported on the frame 118. In the illustrated example of FIG. 1, the ground engaging members 142, 144 include wheels. In other examples, the ground engaging members 142, 144 may include tracks. The ground engaging members 142, 144 support and provide mobility to the work machine 100 on a ground surface.

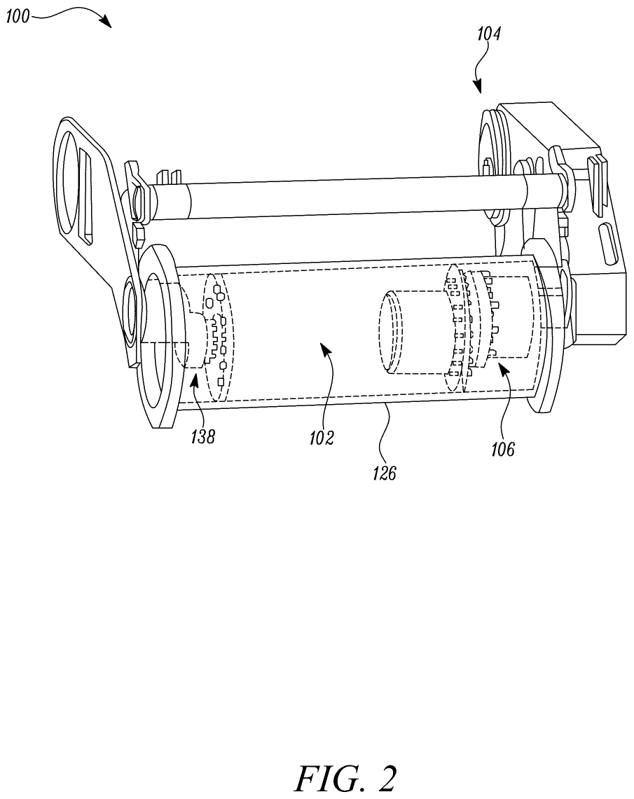

Referring to FIG. 2, the work machine 100 also includes a main clutch 104 supported on the frame 118. The main clutch 104 is coupled to the power source via pulleys (not shown). A drive belt (not shown) is attached in between the pulleys to transmit the power from the power source to the main clutch 104. The main clutch 104 may be operably coupled to the power source by an input drive shaft (not shown).

The work machine 100 further includes a gearbox 106 supported on the frame 118. The gearbox 106 may include a planetary gear arrangement. In some examples, a drive pulley (not shown) is attached to the main clutch 104 and a driven pulley (not shown) is attached to the gearbox 106 and is operably coupled with the drive pulley for transfer of the power to the gearbox 106. The main clutch 104 may act as an engagement/disengagement element between the power source and the gearbox 106.

As shown in FIG. 2, the work machine 100 further includes a rotor 102 adapted to engage with the main clutch 104 via the gearbox 106. The gearbox 106 is operatively coupled to the rotor 102. It should be noted that the gearbox 106 may rotate the rotor 102 at a predetermined speed that can be achieved through different gear ratios obtainable through the gearbox 106.

The rotor 102 includes a drum 126 and a number of cutting and/or mixing tools (not shown herein) coupled to the drum 126. The tools radially extend from an outer surface of the drum 126 and may engage with the work surface being worked. The tools may allow the rotor 102 to remove and/or mix materials during work operations. The drum 126 may be rotatable in a clockwise or an anticlockwise direction for removing material from the work surface.

The rotor 102 also includes a bearing assembly 138. In an example, the rotor 102 may be a hollow structure that may partially house the gearbox 106 and the bearing assembly 138.

The work machine 100 further includes a rotor chamber 130 (shown in FIG. 1). The rotor chamber 130 accommodates the rotor 102 therein.

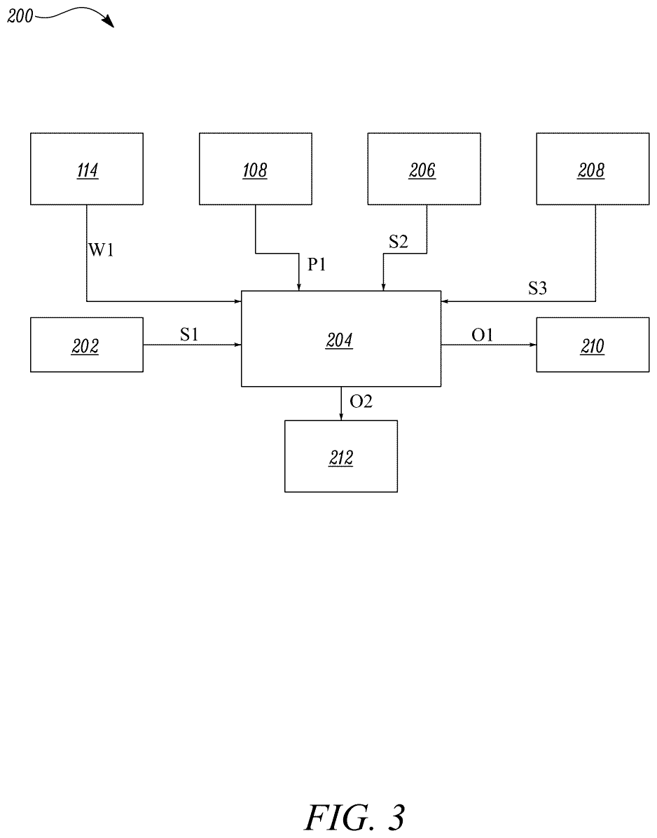

Referring now to FIG. 3, the present disclosure relates to a warning system 200 for the work machine 100 (see FIG. 1). Specifically, the work machine 100 includes the warning system 200.

The warning system 200 includes a first sensor 202 that generates a first signal S1 indicative of a speed of the rotor 102 (see FIG. 2). In an example, the first sensor 202 is a speed sensor that is coupled with the gearbox 106 (see FIG. 2) of the work machine 100 and/or a speed sensor that measures a rotational speed of the rotor 102. Thus, in an example, the speed sensor measures the rotational speed of the gearbox 106 to generate the first signal S1. Alternatively, the first sensor 202 may measure the rotational speed of the rotor 102 to generate the first signal S1. In some examples the first sensor 202 may include a tachometer, an encoder, a magnetic sensor, a hall effect sensor, and the like. The present disclosure is not limited by a type of the first sensor 202 or a technique of measuring the speed of the rotor 102.

The warning system 200 also includes a controller 204 communicably coupled with the first sensor 202. The controller 204 includes one or more memories and one or more processors. The one or more processors are communicably coupled with the one or more memories.

The one or more memories may include any means of storing information, including a hard disk, an optical disk, a floppy disk, read only memory (ROM), random access memory (RAM), programmable ROM (PROM), electrically erasable PROM (EEPROM), or other computer-readable memory media.

It should be noted that the one or more processors may embody a single microprocessor or multiple microprocessors for receiving various input signals and generating output signals. Numerous commercially available microprocessors may perform the functions of the one or more processors. Each processor may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor may include one or more components that may be operable to execute computer executable instructions or computer code that may be stored and retrieved from the one or more memories.

The controller 204 receives the first signal S1 indicative of the speed of the rotor 102 from the first sensor 202. Specifically, the one or more processors receive the first signal S1 indicative of the speed of the rotor 102 from the first sensor 202. The controller 204 determines that the rotor 102 is in an operational mode based on a receipt of the first signal S1 from the first sensor 202.

The controller 204 also determines an engagement between the rotor 102 and the main clutch 104 (see FIG. 2). A machine control unit (MCU) 114 is associated with the work machine 100 to control the operation of the work machine 100. The MCU 114 is communicably coupled with the controller 204 to send a signal W1 regarding the engagement between the rotor 102 and the main clutch 104. In one example, the MCU 114 determines the engagement between the rotor 102 and the main clutch 104 based on an operator command received from the operator of the work machine 100. The MCU 114 actuates the main clutch 104 based on receipt of the operator command. In some examples, the MCU 114 may be in communication with a clutch position sensor attached on the main clutch 104 to determine the engagement between the rotor 102 and the main clutch 104.

The controller 204 further generates a first output signal O1 if the rotor 102 is in the operational mode or the rotor 102 is in engagement with the main clutch 104. The first output signal O1 indicates that the rotor 102 is in the operational mode to a user of the work machine 100. The user may be the operator of the work machine 100 or any other personnel. Thus, if the controller 204 determines that the speed of the rotor 102 is non-zero and/or the rotor 102 is in engagement with the main clutch 104, the controller 204 generates the first output signal O1. In an example, to determine if the rotor 102 is in the operational mode, the controller 204 may compare the first signal S1 with a predetermined threshold value. The pre-determined threshold value may be prestored in the one or more memories of the controller 204. The pre-determined threshold value may be about zero or may have a nominal speed value. If the first signal S1 is greater than the predetermined threshold value, the controller 204 may determine that the rotor 102 is in the operational mode.

Further, when the work machine 100 is placed in a service mode, the rotor 102 is turned OFF, if the rotor 102 is in the operational mode. However, the rotor 102 may continue to spin for some period of time even after it is turned OFF, and it is desirable that the rotor 102 is not approached by any personnel or the operator until the rotor 102 halts completely. In such examples, the controller 204 determines if the work machine 100 is in the service mode. Further, the controller 204 receives the first signal S1 indicative of the speed of the rotor 102 from the first sensor 202. The controller 204 also determines that the rotor 102 is rotating based on the receipt of the first signal S1 from the first sensor 202. Further, the controller 204 generates a second output signal O2 if the work machine 100 is in the service mode and the rotor 102 is rotating. Specifically, the controller 204 generates the second output signal O2 if the work machine 100 is in the service mode and if the speed of the rotor 102 is not zero, thereby indicating that the rotor 102 is still rotating.

In one example, the controller 204 determines if the work machine 100 is in the service mode based on an input P1 received from a service mode switch 108. The work machine 100 includes the service mode switch 108 that is operable to switch the work machine 100 to the service mode. In case the service mode switch 108 of the work machine 100 is in an ON state, the service mode switch 108 generates the input P1 indicating that the work machine 100 is in the service mode. The controller 204 is communicably coupled with the service mode switch 108 to receive the input P1 from the service mode switch 108. The service mode switch 108 may be disposed within the operator cabin 122 (see FIG. 1) or the service mode switch 108 may be disposed proximal to the rotor chamber 130 (see FIG. 1) on the frame 118 (see FIG. 1) of the work machine 100.

In another example, the controller 204 determines if the work machine 100 is in the service mode based on a position of a rotor door 120 (shown in FIG. 1) of the work machine 100. Specifically, the work machine 100 includes the rotor door 120 that encloses the rotor 102. The rotor door 120 is movable between an open position and a closed position. The warning system 200 further includes a second sensor 206 that generates a second signal S2. The second signal S2 indicates that the rotor door 120 is in the open position. In other words, the second sensor 206 determines if the rotor door 120 is in the open position and accordingly generates the second signal S2.

In some examples, the second sensor 206 associated with the rotor door 120 may include a position sensor that detects a distance between the rotor door 120 and a rotor door closing location to generate the second signal S2. In other examples, the second sensor 206 may include one or more perception sensors, such as cameras, that provides an indication of points of contact between the rotor door 120 and the rotor door closing location that may eventually be used to determine if the rotor door 120 is in the open position. Further, in such examples, the controller 204 determines if the work machine 100 is in the service mode based on the receipt of the second signal S2 from the second sensor 206.

In yet another example, the controller 204 determines if the work machine 100 is in the service mode based on a presence or an absence of the operator in the operator cabin 122. Specifically, the controller 204 determines that the work machine 100 is in the service mode if the operator is absent/not present in the operator cabin 122. In such example, the warning system 200 further includes a third sensor 208 that generates a third signal S3 indicative of the presence of the operator in the operator cabin 122 of the work machine 100.

In some examples, the third sensor 208 may include a weight sensor disposed proximal to a seat of the operator to detect the presence of the operator within the operator cabin 122. In another example, the third sensor 208 may include one or more perception sensors, such as cameras, that provide an indication of the presence of the operator in the operator cabin 122. The perception sensors may capture images and/or videos to detect the presence of the operator in the operator cabin 122. The third sensor 208 may also include an operator switch present in the operator cabin 122. The operator may switch on the operator switch to indicate his/her presence within the operator cabin 122. In such an example, the controller 204 determines if the work machine 100 is in the service mode based on an absence of the third signal S3 from the third sensor 208. The controller 204 is communicably coupled with the third sensor 208 to receive the third signal S3 from the third sensor 208.

In yet another example, when the work machine 100 includes the cold planer, the controller 204 determines if the work machine 100 is in the service mode based on a disposal of the work machine 100 at a service height. In an example, the MCU 114 may transmit an information related to a current height of the work machine 100 to the controller 204. The controller 204 may compare the information related to the current height of the work machine 100 with the service height. The service height may be predetermined and stored within the memories of the controller 204. If the current height is greater than the service height, the controller 204 determines that the work machine 100 is in the service mode. In an example, the work machine 100 may include one or more sensors that determine the current height of the work machine 100. The sensors may include a displacement sensor, an ultrasonic sensor, a Light Detection and Ranging (LIDAR), a Radio Detection and Ranging (RADAR), and so on.

Further, the warning system 200 includes one or more output devices 210, 212 that receive the first output signal O1 and/or the second output signal O2 from the controller 204. The output devices 210, 212 are communicably coupled with the controller 204 to receive the first output signal O1 and/or the second output signal O2 from the controller 204.

The one or more output devices 210, 212 generate a first notification based on the receipt of the first output signal O1 and/or a second notification based on the receipt of the second output signal O2. In the illustrated example of FIG. 3, the warning system 200 includes two output devices 210, 212. Alternatively, the warning system 200 may include a single output device that generates each of the first notification and the second notification.

Specifically, the first notification is a visual notification. In such cases, the first output device 210 may include a strobe, a light system, a display device such as, a Liquid Crystal Display (LCD) panel or Light Emitting Diode (LED) display panels, a smart phone, a laptop, a tablet, and so on. Further, the second notification is an audible notification. In some examples, the audible notification may include a voice message, a buzzer, and so on. In such examples, the second output device 212 may include a speaker, a device that generates audible alerts, and so on. In some examples, the first and/or second notifications may include flashing lights along with a voice message. Alternatively, each of the first notification and the second notification may include any other type of notifications, without any limitations.

Further, the one or more output devices 210, 212 may be located within the operator cabin 122 or outside the operator cabin 122, for example, on the frame 118 of the work machine 100.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### Industrial Applicability

The present disclosure describes the warning system 200 for the work machine 100. The warning system 200 notifies the operators if the rotor 102 is in the operational mode and/or whether the work machine 100 is in the service mode before the operators or other personnel access the rotor 102 for maintenance and/or servicing. Specifically, the first notification and/or the second notification is generated for the operator/personnel when the rotor 102 is in the operational mode. The first and second notifications may direct the operator to stay away from the rotor 102. The first and second notifications may prevent the operator from reaching a vicinity of the rotor 102 when the rotor 102 is in the operational mode.

The warning system 200 is simple in construction, includes fewer components, may be cost effective, and may be retrofitted on existing work machines.

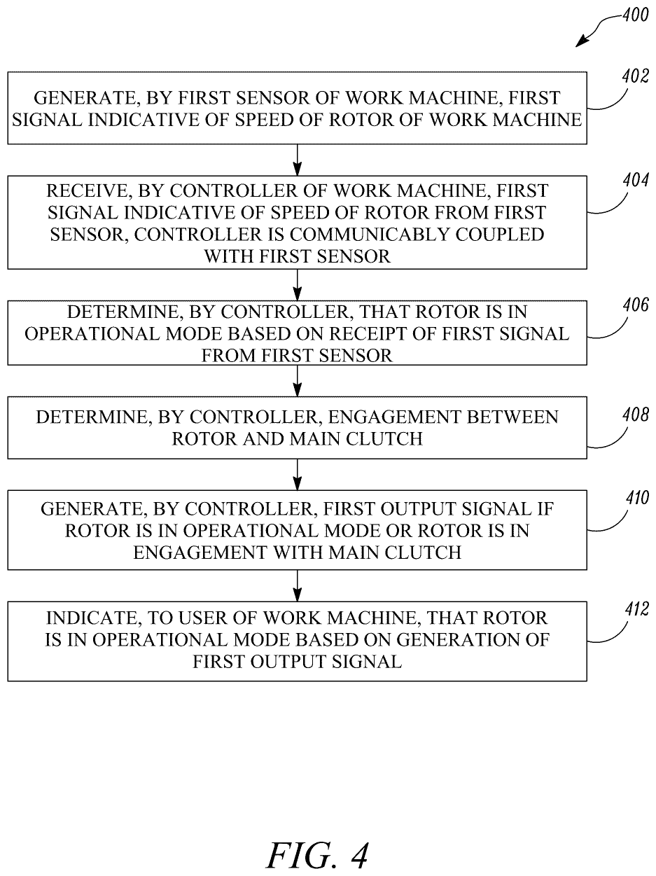

FIG. 4 is a flowchart for a method 400 of generating a warning for the work machine 100. With reference to FIGS. 1 to 4, at step 402, the first sensor 202 generates the first signal S1 indicative of the speed of the rotor 102 of the work machine 100.

At step 404, the controller 204 of the work machine 100 receives the first signal S1 indicative of the speed of the rotor 102 from the first sensor 202. The controller 204 is communicably coupled with the first sensor 202.

At step 406, the controller 204 determines that the rotor 102 is in the operational mode based on the receipt of the first signal S1 from the first sensor 202.

At step 408, the controller 204 determines the engagement between the rotor 102 and the main clutch 104 of the work machine 100.

At step 410, the controller 204 generates the first output signal O1 if the rotor 102 is in the operational mode or the rotor 102 is in engagement with the main clutch 104.

At step 412, the user of the work machine 100 is indicated that the rotor 102 is in the operational mode based on the generation of the first output signal O1.

The method 400 includes a step (not shown) at which the controller 204 determines if the work machine 100 is in the service mode. The method 400 also includes a step (not shown) at which the controller 204 receives the first signal S1 indicative of the speed of the rotor 102 from the first sensor 202. The method 400 further includes a step (not shown) at which the controller 204 determines that the rotor 102 is rotating based on the receipt of the first signal S1 from the first sensor 202. The method 400 further includes a step (not shown) at which the controller 204 generates the second output signal O2 if the work machine 100 is in the service mode and the rotor 102 is rotating.

In an example, the method 400 further includes a step (not shown) at which the controller 204 receives the input P1 from the service mode switch 108 of the work machine 100 to determine if the work machine 100 is in the service mode. The service mode switch 108 is operable to switch the work machine 100 to the service mode. The controller 204 is communicably coupled with the service mode switch 108.

In another example, the method 400 further includes a step (not shown) at which the controller 204 receives the second signal S2 from the second sensor 206 of the work machine 100 to determine if the work machine 100 is in the service mode. The work machine 100 includes the rotor door 120 that encloses the rotor 102. The rotor door 120 is movable between the open position and the closed position. The second sensor 206 indicates that the rotor door 120 is in the open position. The controller 204 is communicably coupled with the second sensor 206.

In yet another example, the method 400 further includes a step (not shown) at which the controller 204 determines that the work machine 100 is in the service mode based on the absence of the third signal S3 from the third sensor 208 of the work machine 100. The third signal S3 indicates the presence of the operator in the operator cabin 122 of the work machine 100. The controller 204 is communicably coupled with the third sensor 208.

In yet another example, the method 400 further includes a step (not shown) at which the controller 204 receives the information related to the disposal of the work machine 100 at the service height to determine if the work machine 100 is in the service mode.

The method 400 further includes a step (not shown) at which the one or more output devices 210, 212 of the work machine 100 receive the first output signal O1 and/or the second output signal O2 from the controller 204. The controller 204 is communicably coupled with the one or more output devices 210, 212. The method 400 further includes a step (not shown) at which the one or more output devices 210, 212 generate the first notification based on the receipt of the first output signal O1 and/or the second notification based on the receipt of the second output signal O2.

It should be noted that the steps 402, 404, 406, 408, 410, 412 of the method 400 may be performed in a sequence that is different from that explained in relation to FIG. 4. Further, various steps 402, 404, 406, 408, 410, 412 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. A warning system for a work machine, the work machine including a rotor adapted to engage with a main clutch of the work machine, the warning system comprising:
a first sensor configured to generate a first signal indicative of a speed of the rotor; and
a controller communicably coupled with the first sensor, wherein the controller is configured to:
receive the first signal indicative of the speed of the rotor from the first sensor;
determine that the rotor is in an operational mode based on a receipt of the first signal from the first sensor;
determine an engagement between the rotor and the main clutch; and
generate a first output signal if the rotor is in the operational mode or the rotor is in engagement with the main clutch, wherein the first output signal indicates that the rotor is in the operational mode to a user of the work machine.

2. The warning system of claim 1, wherein the first sensor is any one of a speed sensor that is coupled with a gearbox of the work machine and a speed sensor that measures a rotational speed of the rotor.

3. The warning system of claim 1, wherein the controller is further configured to:
determine if the work machine is in a service mode;
receive the first signal indicative of the speed of the rotor from the first sensor;
determine that the rotor is rotating based on the receipt of the first signal from the first sensor; and
generate a second output signal if the work machine is in the service mode and the rotor is rotating.

4. The warning system of claim 3, wherein the work machine includes a service mode switch that is operable to switch the work machine to a service mode, and wherein the controller is configured to determine if the work machine is in the service mode based on an input received from the service mode switch.

5. The warning system of claim 3, wherein the work machine includes a rotor door that encloses the rotor, wherein the rotor door is movable between an open position and a closed position, wherein the warning system further includes a second sensor configured to generate a second signal configured to indicate that the rotor door is in the open position, and wherein the controller is configured to determine if the work machine is in the service mode based on a receipt of the second signal from the second sensor.

6. The warning system of claim 3 further comprising a third sensor configured to generate a third signal indicative of a presence of an operator in an operator cabin of the work machine, wherein the controller is configured to determine if the work machine is in the service mode based on an absence of the third signal from the third sensor.

7. The warning system of claim 3, wherein the controller is configured to determine if the work machine is in the service mode based on a disposal of the work machine at a service height.

8. The warning system of claim 3 further comprising at least one output device configured to receive the first output signal and/or the second output signal from the controller, wherein the at least one output device is configured to generate a first notification based on a receipt of the first output signal and/or a second notification based on a receipt of the second output signal.

9. The warning system of claim 8, wherein the first notification is a visual notification and the second notification is an audible notification.

10. A work machine comprising:
a frame;
a main clutch supported on the frame;
a gearbox supported on the frame;
a rotor adapted to engage with the main clutch via the gearbox; and
a warning system including:
a first sensor configured to generate a first signal indicative of a speed of the rotor; and
a controller communicably coupled with the first sensor, wherein the controller is configured to:
receive the first signal indicative of the speed of the rotor from the first sensor;
determine that the rotor is in an operational mode based on a receipt of the first signal from the first sensor;
determine an engagement between the rotor and the main clutch; and
generate a first output signal if the rotor is in the operational mode or the rotor is in engagement with the main clutch, wherein the first output signal indicates that the rotor is in the operational mode to a user of the work machine.

11. The work machine of claim 10, wherein the controller is further configured to:
determine if the work machine is in a service mode;
receive the first signal indicative of the speed of the rotor from the first sensor;
determine that the rotor is rotating based on the receipt of the first signal from the first sensor; and
generate a second output signal if the work machine is in the service mode and the rotor is rotating.

12. The work machine of claim 11 further comprising a service mode switch that is operable to switch the work machine to a service mode, wherein the controller is configured to determine if the work machine is in the service mode based on an input received from the service mode switch.

13. The work machine of claim 11 further comprising a rotor door that encloses the rotor, wherein the rotor door is movable between an open position and a closed position, wherein the warning system further includes a second sensor configured to generate a second signal to indicate that the rotor door is in the open position, and wherein the controller is configured to determine if the work machine is in the service mode based on a receipt of the second signal from the second sensor.

14. The work machine of claim 11, wherein the warning system further includes a third sensor configured to generate a third signal indicative of a presence of an operator in an operator cabin of the work machine, and wherein the controller is configured to determine if the work machine is in the service mode based on an absence of the third signal from the third sensor.

15. The work machine of claim 11, wherein the controller is configured to determine if the work machine is in the service mode based on a disposal of the work machine at a service height.

16. The work machine of claim 11, wherein the warning system further includes at least one output device configured to receive the first output signal and/or the second output signal from the controller, and wherein the at least one output device is configured to generate a first notification based on a receipt of the first output signal and/or a second notification based on a receipt of the second output signal.

17. A method of generating a warning for a work machine, the method comprising:
generating, by a first sensor of the work machine, a first signal indicative of a speed of a rotor of the work machine;
receiving, by a controller of the work machine, the first signal indicative of the speed of the rotor from the first sensor, wherein the controller is communicably coupled with the first sensor;
determining, by the controller, that the rotor is in an operational mode based on a receipt of the first signal from the first sensor;
determining, by the controller, an engagement between the rotor and the main clutch; and
generating, by the controller, a first output signal if the rotor is in the operational mode or the rotor is in engagement with the main clutch; and
indicating, to a user of the work machine, that the rotor is in the operational mode based on the generation of the first output signal.

18. The method of claim 17 further comprising:
determining, by the controller, if the work machine is in a service mode;
receiving, by the controller, the first signal indicative of the speed of the rotor from the first sensor;
determining, by the controller, that the rotor is rotating based on the receipt of the first signal from the first sensor; and
generating, by the controller, a second output signal if the work machine is in the service mode and the rotor is rotating.

19. The method of claim 18, wherein the step of determining, by the controller, if the work machine is in the service mode further includes:
receiving, by the controller, an input from a service mode switch of the work machine to determine if the work machine is in a service mode, wherein the service mode switch is operable to switch the work machine to the service mode, and wherein the controller is communicably coupled with the service mode switch;
receiving, by the controller, a second signal from a second sensor of the work machine to determine if the work machine is in the service mode, wherein the work machine includes a rotor door that encloses the rotor, wherein the rotor door is movable between an open position and a closed position, wherein the second sensor is configured to indicate that the rotor door is in the open position, and wherein the controller is communicably coupled with the second sensor;
determining, by the controller, that the work machine is in the service mode based on an absence of a third signal from a third sensor of the work machine, wherein the third signal is configured to indicate a presence of an operator in an operator cabin of the work machine, and wherein the controller is communicably coupled with the third sensor; and/or
receiving, by the controller, an information related to a disposal of the work machine at a service height to determine if the work machine is in the service mode.

20. The method of claim 18 further comprising:
receiving, by at least one output device of the work machine, the first output signal and/or the second output signal from the controller, wherein the controller is communicably coupled with the at least one output device; and
generating, by the at least one output device, a first notification based on a receipt of the first output signal and/or a second notification based on a receipt of the second output signal.
